(19) United States
(12) Patent Application Publication
(10) Pub. No.: US 2014/0141240 A1
(43) Pub. Date: May 22, 2014

(54) HALOGEN-FREE RESIN COMPOSITION, ELECTRIC WIRE AND CABLE

(71) Applicant: Hitachi Metals, Ltd., Tokyo (JP)

(72) Inventors: Kentaro SEGAWA, Kudamatsu (JP); Tamotsu KIBE, Hitachi (JP)

(73) Assignee: Hitachi Metals, Ltd., Tokyo (JP)

(21) Appl. No.: 14/084,056

(22) Filed: Nov. 19, 2013

(30) Foreign Application Priority Data
Nov. 20, 2012 (JP) 2012-254742

(51) Int. Cl. H01B 3/30; H01B 7/295

(52) U.S. Cl. CPC H01B 3/30; H01B 7/295
USPC 428/375; 524/436

(57) ABSTRACT

A halogen-free resin composition includes 100 to 250 parts by mass of metal hydroxide and 3 to 50 parts by mass of amorphous silica per 100 parts by mass of polyolefin-based resin as a base polymer. The amorphous silica has a specific gravity of 2.1 to 2.3 g/cm³ and a specific surface area of 15 to 50 m²/g. An electric wire includes a covering including the halogen-free resin composition. A cable includes the electric wire or a covering including the halogen-free resin composition.

The present application is based on Japanese patent application No.2012-254742 filed on Nov. 20, 2012, the entire contents of which are incorporated herein by reference.

### BACKGROUND OF THE INVENTION

1. Field of the Invention

The invention relates to a halogen-free flame-retardant resin composition, an electric wire covered with the resin composition and a cable using the electric wire.

2. Description of the Related Art

Some halogen-free flame-retardant resin compositions used for insulated wire or cables etc. are prepared by adding a metal hydroxide such as magnesium hydroxide with its surface treated or non-treated to a polyolefin-based resin (see, e.g., JP-A-2000-129049, JP-A-2000-178386 and JP-A-2000-195336).

The flame-retardant resin compositions include no halogen compounds and thus produce no poisonous gas such as hydrogen chloride or hazardous substance such as dioxin when it is burned. Therefore, no toxic gas is generated in the event of a fire, which allows secondary disaster to be prevented, and it is also considered that no problem arises even if incinerated for disposal.

In manufacturing the halogen-free flame-retardant resin compositions, a large amount of a metal hydroxide, which is a halogen-free flame retardant, is generally mixed to a polyolefin so as to improve the flame retardancy.

### SUMMARY OF THE INVENTION

However, due to the large amount of the metal hydroxide added so as to improve the flame retardancy, the shear viscosity of the resin composition increases so that the torque needed at the time of extrusion of the resin composition increases. Therefore, it is necessary to decrease the feed speed of the resin composition. This causes a decrease in the productivity of the resin composition. Furthermore, due to the increase of the additive amount of the metal hydroxide, a problem may arise that mechanical characteristics thereof deteriorate so that a targeted electric wire cannot be obtained.

In addition, especially automotive wires/cables also need to have excellent oil resistance and low-temperature resistance. Thus, the resin compositions need to meet these characteristics.

It is an object of the invention to provide a halogen-free resin composition that has a high flame retardancy, has low viscosity allowing prevention of an increase in torque at the time of extrusion and is excellent in tensile characteristics, as well as an electric wire covered with the resin composition and a cable using the electric wire. Also, it is another object of the invention to provide a halogen-free resin composition that has, in addition to the above characteristics, an oil resistance and low-temperature resistance so as to be suitably used for automotive wires/cables, as well as an electric wire covered with the resin composition and a cable using the electric wire.

(1) According to one embodiment of the invention, a halogen-free resin composition comprises 100 to 250 parts by mass of metal hydroxide and 3 to 50 parts by mass of amorphous silica per 100 parts by mass of polyolefin-based resin as a base polymer,

wherein the amorphous silica has a specific gravity of 2.1 to 2.3 g/cm³ and a specific surface area of 15 to 50 m²/g.

In the above embodiment (1) of the invention, the following modifications and changes can be made.

(i) The polyolefin-based resin comprises a maleic anhydride-modified ethylene-α-olefin-based copolymer.

(ii) The polyolefin-based resin comprises a polyethylene having a melt mass flow rate (MFR) of not more than 2.0 (g/10 min) and a density of 0.900 to 0.925 g/cm³.

(iii) The polyolefin-based resin comprises:

10 to 40 parts by mass of maleic anhydride-modified ethylene-α-olefin-based copolymer; and

60 to 90 parts by mass of polyethylene having a melt mass flow rate (MFR) of not more than 2.0 (g/10 min) and a density of 0.900 to 0.925 g/cm³.

(2) According to another embodiment of the invention, an electric wire comprises a covering comprising the halogen-free resin composition according to the above embodiment (1).
(3) According to another embodiment of the invention, a cable comprises the electric wire according to the above embodiment (2).
(4) According to another embodiment of the invention, a cable comprises a covering comprising the halogen-free resin composition according to the above embodiment (1).

In the above embodiment (3) or (4) of the invention, the following modifications and changes can be made.

(iv) The cable further comprises a sheath comprising the halogen-free resin composition according to the above embodiment (1).

### EFFECTS OF THE INVENTION

According to one embodiment of the invention, a halogen-free resin composition can be provided that has a high flame retardancy, has low viscosity allowing prevention of an increase in torque at the time of extrusion and is excellent in tensile characteristics, as well as an electric wire covered with the resin composition and a cable using the electric wire. Also, a halogen-free resin composition can be provided that has, in addition to the above characteristics, an oil resistance and low-temperature resistance so as to be suitably used for automotive wires/cables, as well as an electric wire covered with the resin composition and a cable using the electric wire.

### BRIEF DESCRIPTION OF THE DRAWINGS

Next, the present invention will be explained in more detail in conjunction with appended drawings, wherein:

FIG. 1 is a cross sectional view showing an electric wire covered with a halogen-free resin composition in an embodiment of the present invention; and

FIG. 2 is a cross sectional view showing a cable in the embodiment of the invention, which has the electric wire of FIG. 1.

### DETAILED DESCRIPTION OF THE PREFERRED EMBODIMENT

### Halogen-Free Resin Composition

A halogen-free resin composition in the embodiment of the invention includes 100 to 250 parts by mass of metal hydroxide and 3 to 50 parts by mass of amorphous silica per 100 parts by mass of polyolefin-based resin as a base polymer. The amorphous silica has a specific gravity of 2.1 to 2.3 g/cm³ and a specific surface area of 15 to 50 m²/g.

As the polyolefin-based resin in the present embodiment, it is exemplary to use at least one or more selected from the group consisting of low-density polyethylene, linear low-density polyethylene, linear very low-density polyethylene, maleic acid grafted linear low-density polyethylene, ethylene-methyl methacrylate copolymer, ethylene methyl acrylate copolymer, ethylene ethyl acrylate copolymer, ethylene vinyl acetate copolymer, ethylene-styrene copolymer, maleic anhydride modified ethylene-α-olefin-based copolymer, ethylene-propylene copolymer, ethylene-butene copolymer, ethylene-octene copolymer and grafted polymers thereof with vinylsilane. Among the above, it is more exemplary to use one or more selected from the group consisting of maleic anhydride modified ethylene-α-olefin-based copolymers and polyethylenes having a melt mass flow rate (MFR) of not more than 2.0 (g/10 min) and a density of 0.900 to 0.925 g/cm³ (polyethylene here means low-density polyethylene, linear low-density polyethylene, linear very low-density polyethylene or maleic acid grafted linear low-density polyethylene. Hereinafter the same applies) from the viewpoint of oil resistance and low-temperature resistance. It is particularly exemplary to combine a maleic anhydride modified ethylene-α-olefin-based copolymer and a polyethylene having a MFR of not more than 2.0 (g/10 min) and a density of 0.900 to 0.925 g/cm³.

If MFR of the polyethylene is more than 2.0 g/10 min, the molecular weight is reduced and the oil resistance decreases. If the density of the polyethylene is less than 0.900 g/cm³, the amount of crystal is not enough and the oil resistance decreases. If it is more than 0.925 g/cm³, the amount of crystal is too much and the elongation decreases.

It is exemplary to add the maleic anhydride modified ethylene-α-olefin-based copolymer so as to be included in an amount of 10 to 40% by mass with respect to the total amount of the polyolefin-based resin as a base polymer. If the content is less than 10% by mass, the adhesion of the polymer to the metal hydroxide and to the amorphous silica is not enough and the low-temperature resistance decreases. If the content is more than 40% by mass, the adhesion is too strong and the elongation decreases.

It is exemplary to add the polyethylene having a MFR of not more than 2.0 (g/10 min) and a density of 0.900 to 0.925 g/cm³ so as to be included in an amount of 60 to 90% by mass with respect to the total amount of the polyolefin-based resin as a base polymer. The amount of crystal is not enough and oil resistance decreases when less than 60% by mass while the amount of crystal is large and elongation decreases when more than 90% by mass.

The metal hydroxide suitably used in the present embodiment can be magnesium hydroxide, aluminum hydroxide, calcium hydroxide or these metal hydroxides with nickel solid-dissolved therein. These may be used alone or in combination of two or more. In addition, theses metal hydroxides can be used after surface treatment with a silane coupling agent, a titanate coupling agent, or fatty acid or fatty acid metal salt such as stearate or calcium stearate. In addition, metal hydroxides other than the above may be added in an appropriate amount.

The metal hydroxide is added as a flame retardant in an amount of 100 to 250 parts by mass per 100 parts by mass of the polyolefin-based resin as a base polymer. Sufficient flame retardancy is not obtained when the added amount is less than 100 parts by mass while mechanical characteristics decrease when more than 250 parts by mass. The added amount of the metal hydroxide is preferably 130 to 220 parts by mass, more preferably 150 to 200 parts by mass.

The amorphous silica which can be used in the present embodiment has a specific gravity of 2.1 to 2.3 g/cm³ and a specific surface area of 15 to 50 m²/g. Use of such amorphous silica allows the effect of the invention to be obtained. For the amorphous silica, the specific gravity is preferably 2.15 to 2.25 g/cm³ and the specific surface area is preferably 30 to 50 m²/g.

The amorphous silica is added as a flame-retardant aid in an amount of 3 to 50 parts by mass per 100 parts by mass of the polyolefin-based resin as a base polymer. Sufficient flame retardancy is not obtained when the added amount is less than 3 parts by mass while mechanical characteristics significantly decrease when more than 50 parts by mass. The added amount of the amorphous silica is preferably 3 to 30 parts by mass, more preferably 5 to 20 parts by mass.

Other than the above-mentioned flame retardants and flame-retardant aids, it is possible, if necessary, to add additives such as antioxidants, lubricants, softeners, plasticizers, inorganic fillers, compatibilizing agents, stabilizers, carbon black and colorants within a range not impairing characteristics of the invention. In addition, flame retardants and flame-retardant aids other than those mentioned above may be added within a range not impairing characteristics of the invention in order to further improve performance.

It is exemplary that the halogen-free resin composition in the embodiment of the invention be cross-linked. Mechanical characteristics of the resin composition to be obtained are improved by cross-linking. The cross-linking method used is an electron beam crosslinking method in which an electron beam is irradiated after molding or a chemical crosslinking method in which a resin composition pre-mixed with a cross-linking agent is molded and is then cross-linked by heating.

The halogen-free resin composition in the exemplary embodiment of the invention is excellent in workability due to its low viscosity at the time of extrusion, is also excellent in flame retardancy, mechanical characteristics, oil resistance and low-temperature resistance, and thus can be widely used for automotive components, tubes, adhesives and building materials, etc.

### Electric Wire and Cable

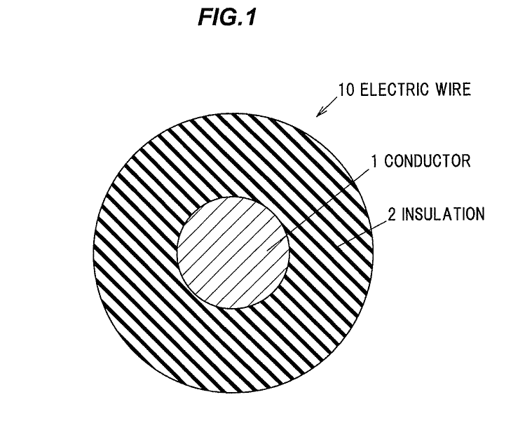

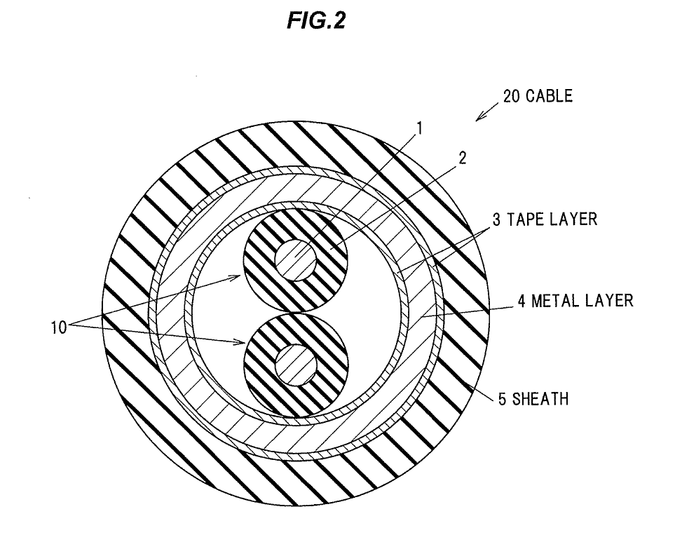

FIG. 1 is a cross sectional view showing an electric wire covered with the halogen-free resin composition in the embodiment of the invention. FIG. 2 is a cross sectional view showing a cable in the embodiment of the invention, which has the electric wire of FIG. 1.

An electric wire 10 shown in FIG. 1 is an electric wire in which a conductor 1 formed of copper is covered with an insulation 2 formed of the halogen-free resin composition in the embodiment of the invention. The thickness of the insulation 2 is preferably 0.1 to 1.5 mm, more preferably 0.3 to 1.2 mm.

In the electric wire 10 in the embodiment of the invention, the number of insulation layers is not limited to one. Plural insulation layers or other middle layers may be provided as long as the effects of the invention are exerted.

Meanwhile, a cable 20 shown in FIG. 2 is a cable in which a tape layer 3 such as resin tape (PET tape, etc.) is provided around an outer periphery of two aligned electric wires 10 of FIG. 1, a metal layer 4 formed of metal braid, etc., and another tape layer 3 are provided, if necessary, on the outer side thereof and the outermost periphery thereof is covered with a sheath 5 formed of the halogen-free resin composition in the embodiment of the invention.

Note that, in the cable 20 having the sheath 5 formed of the halogen-free resin composition in the embodiment of the invention, an electric wire covered with the insulation 2 not using the halogen-free resin composition in the embodiment of the invention can be also used.

The electric wire and cable in the exemplary embodiment of the invention do not produce poisonous gas when being burnt and have high flame retardancy, excellent mechanical characteristics, oil resistance and low-temperature resistance.

The invention will be described in more detail in reference to the following Examples but the invention is not limited thereto.

### Examples

Electric wires in Examples and Comparative Examples were made as follows.

Components blended according to the proportion shown in Tables 1 and 2 were kneaded using a 25-liter pressure kneader at a start temperature of 40° C. and an end temperature of 200° C. and were then formed into pellets. Using a 65-mm extruder, the obtained pellets were extrusion-molded on a conductor having an outer diameter of 1.1 mm at a preset temperature of 200° C. so that an insulation has a thickness of 0.7 mm. After extrusion-molding, radiation crosslinking was performed at 7 Mrad, thereby making electric wires.

The electric wires were evaluated by the following methods. Tables 1 and 2 show the evaluation results.

### (1) Tensile Test

A tensile test was conducted on the obtained electric wires in accordance with EN 60811-1-1. Tensile strength of not less than 10 MPa and elongation of not less than 150% were regarded as “Passed (∘)”.

### (2) Flame-Retardant Test

A vertical flame test was conducted on the obtained electric wires in accordance with EN 60332-1-2. A distance between a lower edge of an upper support member and a boundary of a carbonized portion was measured after flame extinction, and less than 50 mm was regarded as “Failed (X)” and not less than 50 mm was regarded as “Passed (∘)”.

### (3) Viscosity Test

Viscosity of pellets of the mixture was measured using a Capilograph 1B manufactured by Toyo Seiki Seisaku-sho, Ltd. The viscosity when extruding pellets from a 5.0 mm-long capillary having an outer diameter of 1.0 mm at a shear rate of 6.1×10³ sec⁻¹ was measured at a measurement temperature of 200° C. Viscosity of less than 270 Pa·s was regarded as “Passed (∘)” and more than 270 Pa·s was regarded as “Failed (X)”.

### (4) Oil Resistance Test

In accordance with EN 60811-1-3, the obtained electric wires were immersed in test oil IRM 902, were heated in a constant-temperature oven at 100° C. for 72 hours and were then left at room temperature for about 16 hours. Then, a tensile test was conducted and a value after oil immersion and heating (percentage of retention) with respect to the initial value was evaluated. Not less than 70% of tensile strength retention and not less than 60% of elongation retention were regarded as “Passed (∘)”.

### (5) Low-Temperature Resistant Test

In accordance with EN 60811-1-4 8.1, a cold bending test was conducted on the obtained electric wire at −40° C. The electric wires in which cracks appeared at the time of bending were regarded as “Failed (X)” and those without cracks were regarded as “Passed (∘)”.

### (6) Comprehensive Evaluation

The electric wires which passed all of the tensile test, the flame-retardant test, the viscosity test, the oil resistant test and the low-temperature resistant test were evaluated as “excellent (⊚)”, the electric wires which passed the tensile test, the flame-retardant test and the viscosity test but failed any of the oil resistant test or the low-temperature resistant test were evaluated as “acceptable (∘)”, and the electric wires which failed any of the tensile test, the flame-retardant test and the viscosity test were evaluated as “not acceptable (X)”.

### Materials Used

### (Base Polymer)

Polymer A (linear low-density polyethylene), Trade name: Evolue SP1510 manufactured by Prime Polymer Co., Ltd., Density: 0.915 g/cm³, MFR: 1.0 g/10 min
Polymer B (linear low-density polyethylene), Trade name: Evolue SP2030 manufactured by Prime Polymer Co., Ltd., Density: 0.922 g/cm³, MFR: 2.5 g/10 min
Polymer C (maleic anhydride modified ethylene-α-olefin-based copolymer), Trade name: Tafmer MH5040 manufactured by Mitsui Chemicals, Inc.
Polymer D (ethylene-vinyl acetate copolymer), Trade name: Evaflex 45X manufactured by Du Pont-Mitsui Polychemicals Co., Ltd.
Polymer E (ethylene-ethyl acrylate copolymer), Trade name: Rexpearl A1150 manufactured by Japan Polyethylene Corporation
(Evolue, Tafmer, Evaflex and Rexpearl are registered trademarks.)

### (Flame Retardant)

Magnesium hydroxide, Trade name: Magseeds S4 manufactured by Konoshima Chemical Co., Ltd. (Magseeds is a registered trademark.)

### (Flame-Retardant Aid)

Amorphous silica A, Trade name: SIDISTAR T120U manufactured by Elkem Japan K.K., Specific gravity: 2.2 g/cm³, Specific surface area: 40 m²/g
Crystalline silica, Trade name: Aerosil R972 manufactured by Nippon Aerosil Co., Ltd.
Amorphous silica B, Trade name: Vulkasil A-1 manufactured by Bayer AC; Specific gravity: 2.0 g/cm³, Specific surface area: 65 m²/g
Amorphous silica C, Trade name: Durosil manufactured by Degussa AC; Specific gravity: 2.1 g/cm³, Specific surface area: 60 m²/g

### (Crosslinking Aid)

Trimethylolpropane trimethacrylate, Trade name: TMPT manufactured by Shin-Nakamura Chemical Co., Ltd.

### (Antioxidant)

Antioxidant A, Trade name: ADK STAB A0-18 manufactured by ADEKA Corporation (ADK STAB is a registered trademark.)
Antioxidant B, Trade name: Irganox1010 manufactured by BASF (Irganox is a registered trademark.)

### (Lubricant)

Zinc stearate, Trade name: EZ101 manufactured by Katsuta Kako Co., Ltd.

### (Colorant)

Carbon black, Trade name: Asahi Thermal FT manufactured by Asahi Carbon Co., Ltd. (Asahi Thermal is a registered trademark.)

TABLE 1

| | | | Example | | | | | | | | | | | |
|---|---|---|---|---|---|---|---|---|---|---|---|---|---|---|
| | Blending amount (parts by mass) | | 1 | 2 | 3 | 4 | 5 | 6 | 7 | 8 | 9 | 10 | 11 | 12 |
| Composition | Polymer A | | 80 | 70 | 70 | 80 | 80 | 80 | 80 | 60 | 90 | | 100 | |
| | Polymer B | | | | | | | | | | | 80 | | |
| | Polymer C | | 20 | 30 | 20 | 20 | 20 | 20 | 20 | 40 | 10 | 20 | | |
| | Polymer D | | | | 10 | | | | | | | | | |
| | Polymer E | | | | | | | | | | | | | 100 |
| | Magnesium hydroxide | | 180 | 180 | 180 | 180 | 180 | 100 | 250 | 180 | 180 | 180 | 180 | 180 |
| | Amorphous silica A | | 10 | 10 | 10 | 3 | 50 | 10 | 10 | 10 | 10 | 10 | 10 | 10 |
| | Trimethylolpropane trimethacrylate | | 2 | 2 | 2 | 2 | 2 | 2 | 2 | 2 | 2 | 2 | 2 | 2 |
| | Antioxidant A | | 1 | 1 | 1 | 1 | 1 | 1 | 1 | 1 | 1 | 1 | 1 | 1 |
| | Antioxidant B | | 2 | 2 | 2 | 2 | 2 | 2 | 2 | 2 | 2 | 2 | 2 | 2 |
| | Zinc stearate | | 1 | 1 | 1 | 1 | 1 | 1 | 1 | 1 | 1 | 1 | 1 | 1 |
| | Carbon black | | 5 | 5 | 5 | 5 | 5 | 5 | 5 | 5 | 5 | 5 | 5 | 5 |
| Evaluation | Tensile | Tensile strength (MPa) | ◯ | ◯ | ◯ | ◯ | ◯ | ◯ | ◯ | ◯ | ◯ | ◯ | ◯ | ◯ |
| results | test | | 18.1 | 18.7 | 19.5 | 18.2 | 19.0 | 17.5 | 21.2 | 17.3 | 22.5 | 15.4 | 17.7 | 18.0 |
| | | Elongation (%) | ◯ | ◯ | ◯ | ◯ | ◯ | ◯ | ◯ | ◯ | ◯ | ◯ | ◯ | ◯ |
| | | | 177 | 163 | 180 | 187 | 153 | 280 | 150 | 150 | 247 | 190 | 163 | 320 |
| | Flame-retardant test (mm) | | ◯ | ◯ | ◯ | ◯ | ◯ | ◯ | ◯ | ◯ | ◯ | ◯ | ◯ | ◯ |
| | | | 432 | 435 | 429 | 433 | 433 | 431 | 436 | 435 | 430 | 433 | 434 | 432 |
| | Viscosity test: Viscosity (Pa · s) | | ◯ | ◯ | ◯ | ◯ | ◯ | ◯ | ◯ | ◯ | ◯ | ◯ | ◯ | ◯ |
| | | | 258 | 261 | 251 | 243 | 257 | 204 | 269 | 268 | 225 | 252 | 218 | 209 |
| | Oil | Tensile strength retention (%) | ◯ | ◯ | ◯ | ◯ | ◯ | ◯ | ◯ | ◯ | ◯ | X | ◯ | X |
| | resistant | | 75 | 74 | 78 | 75 | 73 | 72 | 74 | 70 | 82 | 69 | 83 | 55 |
| | test | Elongation retention (%) | ◯ | ◯ | ◯ | ◯ | ◯ | ◯ | ◯ | ◯ | ◯ | ◯ | ◯ | X |
| | | | 77 | 71 | 78 | 76 | 71 | 70 | 81 | 63 | 91 | 63 | 95 | 43 |

| | | | | | | | | | | | | |
|---|---|---|---|---|---|---|---|---|---|---|---|---|
| Low-temperature resistant test | ◯ | ◯ | ◯ | ◯ | ◯ | ◯ | ◯ | ◯ | ◯ | ◯ | X | ◯ |
| Comprehensive evaluation | ⊚ | ⊚ | ⊚ | ⊚ | ⊚ | ⊚ | ⊚ | ⊚ | ⊚ | ◯ | ◯ | ◯ |

TABLE 2

| | | | Comparative Example | | | | | | |
|---|---|---|---|---|---|---|---|---|---|
| | Blending amount (parts by mass) | | 1 | 2 | 3 | 4 | 5 | 6 | 7 |
| Composition | Polymer A | | 80 | 80 | 80 | 80 | 80 | 80 | 80 |
| | Polymer C | | 20 | 20 | 20 | 20 | 20 | 20 | 20 |
| | Magnesium hydroxide | | 95 | 255 | 180 | 180 | 180 | 180 | 180 |
| | Amorphous silica A | | 10 | 10 | 2 | 55 | | | |
| | Crystalline silica | | | | | | 10 | | |
| | Amorphous silica B | | | | | | | 10 | |
| | Amorphous silica C | | | | | | | | 10 |
| | Trimethylolpropane trimethacrylate | | 2 | 2 | 2 | 2 | 2 | 2 | 2 |
| | Antioxidant A | | 1 | 1 | 1 | 1 | 1 | 1 | 1 |
| | Antioxidant B | | 2 | 2 | 2 | 2 | 2 | 2 | 2 |
| | Zinc stearate | | 1 | 1 | 1 | 1 | 1 | 1 | 1 |
| | Carbon black | | 5 | 5 | 5 | 5 | 5 | 5 | 5 |
| Evaluation | Tensile | Tensile strength (MPa) | ◯ | ◯ | ◯ | ◯ | ◯ | ◯ | ◯ |
| results | test | | 17.7 | 21.2 | 18.0 | 18.9 | 19.9 | 19.2 | 19.5 |
| | | Elongation (%) | ◯ | X | ◯ | X | ◯ | ◯ | ◯ |
| | | | 283 | 147 | 190 | 147 | 150 | 153 | 150 |
| | Flame-retardant test (mm) | | X | ◯ | X | ◯ | X | X | ◯ |
| | | | 0 | 430 | 0 | 431 | 0 | 0 | 433 |
| | Viscosity test: Viscosity (Pa · s) | | ◯ | ◯ | ◯ | ◯ | X | ◯ | X |
| | | | 200 | 269 | 242 | 261 | 275 | 264 | 276 |
| | Oil | Tensile strength retention (%) | ◯ | ◯ | ◯ | ◯ | ◯ | ◯ | ◯ |
| | resistant | | 71 | 75 | 77 | 72 | 77 | 73 | 75 |
| | test | Elongation retention (%) | ◯ | ◯ | ◯ | ◯ | ◯ | ◯ | ◯ |
| | | | 68 | 83 | 75 | 70 | 78 | 77 | 76 |

| | | | | | | | |
|---|---|---|---|---|---|---|---|
| Low-temperature resistant test | ◯ | ◯ | ◯ | ◯ | ◯ | ◯ | ◯ |
| Comprehensive evaluation | X | X | X | X | X | X | X |

The electric wires in Examples 1 to 9 passed all of the tensile test (tensile strength and elongation), the flame-retardant test (vertical flame test), the viscosity test, the oil resistant test and the low-temperature resistant test and exhibited good characteristics. The electric wires in Examples 10 to 12 failed the oil resistant test or the low-temperature resistant test but exhibited good characteristics in the tensile test (tensile strength and elongation), the flame-retardant test (vertical flame test) and the viscosity test.

Meanwhile, in Comparative Example 1, the added amount of magnesium hydroxide was 95 parts by mass which is less than the range of 100 to 250 parts by mass defined in the invention, resulting in insufficient flame retardancy. On the other hand, in Comparative Example 2, the added amount of magnesium hydroxide was 255 parts by mass which is more than the range of 100 to 250 parts by mass defined in the invention, resulting in insufficient elongation.

In Comparative Example 3, the added amount of amorphous silica was 2 parts by mass which is less than the range of 3 to 50 parts by mass defined in the invention, resulting in insufficient flame retardancy. On the other hand, in Comparative Example 4, the added amount of amorphous silica was 55 parts by mass which is more than the range of 3 to 50 parts by mass defined in the invention, resulting in insufficient elongation.

In Comparative Example 5 using crystalline silica, viscosity was high and char layer formation was small, resulting in insufficient flame retardancy. In Comparative Example 6 using amorphous silica having a specific gravity of 2.0 which is less than the range of 2.1 to 2.3 g/cm³ defined in the invention, char layer formation was small, resulting in insufficient flame retardancy. In Comparative Example 7 using amorphous silica having a specific surface area of 60 m²/g which is greater than the range of 15 to 50 m²/g defined in the invention, viscosity was high, hence, unsatisfactory.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

1. A halogen-free resin composition, comprising 100 to 250 parts by mass of metal hydroxide and 3 to 50 parts by mass of amorphous silica per 100 parts by mass of polyolefin-based resin as a base polymer,
wherein the amorphous silica has a specific gravity of 2.1 to 2.3 g/cm³ and a specific surface area of 15 to 50 m²/g.

2. The halogen-free resin composition according to claim 1, wherein the polyolefin-based resin comprises a maleic anhydride-modified ethylene-α-olefin-based copolymer.

3. The halogen-free resin composition according to claim 1, wherein the polyolefin-based resin comprises a polyethylene having a melt mass flow rate (MFR) of not more than 2.0 (g/10 min) and a density of 0.900 to 0.925 g/cm³.

4. The halogen-free resin composition according to claim 1, wherein the polyolefin-based resin comprises:
10 to 40 parts by mass of maleic anhydride-modified ethylene-α-olefin-based copolymer; and
60 to 90 parts by mass of polyethylene having a melt mass flow rate (MFR) of not more than 2.0 (g/10 min) and a density of 0.900 to 0.925 g/cm³.

5. An electric wire, comprising a covering comprising a halogen-free resin composition, comprising 100 to 250 parts by mass of metal hydroxide and 3 to 50 parts by mass of amorphous silica per 100 parts by mass of polyolefin-based resin as a base polymer,
wherein the amorphous silica has a specific gravity of 2.1 to 2.3 g/cm³ and a specific surface area of 15 to 50 m²/g.

6. A cable, comprising the electric wire according to claim 5.

7. A cable, comprising a covering comprising a halogen-free resin composition, comprising 100 to 250 parts by mass of metal hydroxide and 3 to 50 parts by mass of amorphous silica per 100 parts by mass of polyolefin-based resin as a base polymer,
wherein the amorphous silica has a specific gravity of 2.1 to 2.3 g/cm³ and a specific surface area of 15 to 50 m²/g.

8. The cable according to claim 6, further comprising a sheath comprising the halogen-free resin composition.

9. The cable according to claim 7, further comprising a sheath comprising the halogen-free resin composition.
